(19) United States
(12) Patent Application Publication
(10) Pub. No.: US 2021/0348656 A1
(43) Pub. Date: Nov. 11, 2021

(54) CLUTCH PISTON

(71) Applicant: NOK CORPORATION, Tokyo (JP)

(72) Inventor: Kiichiro GOTO, Fukushima (JP)

(73) Assignee: NOK CORPORATION, Tokyo (JP)

(21) Appl. No.: 17/281,036

(22) PCT Filed: Dec. 12, 2019
(86) PCT No.: PCT/JP2019/048679

§ 371 Date: Mar. 29, 2021

(30) Foreign Application Priority Data
Dec. 25, 2018 (JP) 2018-240801

(51) Int. Cl. F16D 25/0638; F16D 25/12; F15B 15/14

(52) U.S. Cl. CPC F16D 25/0638; F16D 2300/08; F15B 15/1452; F16D 25/123

(57) ABSTRACT

A clutch piston includes a piston that reciprocates in a piston chamber into which an oil flows, and a sealing member configured to seal the oil in the piston chamber. The sealing member includes a proximal portion mounted to an end of the piston and a seal lip that slides on a wall surface of the piston chamber when the piston reciprocates. The end of the piston extends in a direction intersecting the wall surface. The end includes a far-side face disposed on a far side of the piston chamber and a near-side face disposed on a near side of the piston chamber. The near-side face includes a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

### TECHNICAL FIELD

The present invention relates to clutch pistons for actuating clutches of transmissions.

### BACKGROUND ART

There is known a clutch piston for actuating a multiplate clutch of a transmission used in an automobile or the like, for example, an automatic transmission (AT) or a continuously variable transmission (CVT) (Patent Document 1). The clutch piston has a piston that reciprocates in a piston chamber into which oil flows, and a sealing member attached to the piston for sealing the oil in the piston chamber. The piston actuates the multiplate clutch.

### BACKGROUND DOCUMENTS

### Patent Document

Patent Document 1: JP-A-2006-242311

### SUMMARY OF THE INVENTION

For clutch pistons, it is desirable to facilitate manufacture of a part to which a sealing member is mounted.

Accordingly, the present invention provides a clutch piston that facilitates manufacture of a part to which the sealing member is mounted.

A clutch piston according to an aspect of the present invention includes a piston that reciprocates in a piston chamber into which oil flows, and a sealing member configured to seal oil in the piston chamber. The sealing member includes a proximal portion mounted to an end of the piston and a seal lip that slides on a wall surface of the piston chamber when the piston reciprocates. The end of the piston extends in a direction intersecting the wall surface. The end includes a far-side face disposed on a far side of the piston chamber and a near-side face disposed on a near side of the piston chamber. The near-side face includes a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

In this aspect, the near-side face of the end of the piston to which the sealing member is attached has an inclined surface that connects the recessed surface and the projecting surface. Since the inclined surface is inclined relative to the projecting surface, burrs are unlikely to occur at the boundary between the inclined surface and the projecting surface during a cutting process of the piston, and thus, a process for removing burrs either is not necessary or takes only a short time. Furthermore, since the angle between the inclined surface and the recessed surface is obtuse, the nose at the tip of the cutting tool (e.g. a tool bit for lathes) for processing the inclined surface and the recessed surface during the cutting process of the piston may have a large radius of curvature. Accordingly, a processing time can be shortened. Thus, it is easy to manufacture the end of the piston to which the sealing member is attached.

A clutch piston according to an aspect of the present invention includes a piston that reciprocates in a piston chamber into which oil flows, a canceller that faces the piston and defines an oil chamber between the piston and the canceller, and a sealing member configured to seal oil in the oil chamber. The sealing member includes a proximal portion mounted to an end of the canceller and a seal lip that slides on an internal wall surface of the piston when the piston reciprocates, the internal wall surface of the piston forming the oil chamber. The end of the canceller extends in a direction intersecting the internal wall surface. The end includes a far-side face disposed on a far side of the oil chamber and a near-side face disposed on a near side of the oil chamber. The near-side face includes a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

In this aspect, the near-side face of the end of the canceller to which the sealing member is attached has an inclined surface that connects the recessed surface and the projecting surface. Since the inclined surface is inclined relative to the projecting surface, burrs are unlikely to occur at the boundary between the inclined surface and the projecting surface during a cutting process of the canceller, and thus, a process for removing burrs either is not necessary or takes only a short time. Furthermore, since the angle between the inclined surface and the recessed surface is obtuse, the nose at the tip of the cutting tool (e.g. a tool bit for lathes) for processing the inclined surface and the recessed surface during the cutting process of the canceller may have a large radius of curvature. Accordingly, a processing time can be shortened. Thus, it is easy to manufacture the end of the canceller to which the sealing member is attached.

### BRIEF DESCRIPTION OF THE DRAWINGS

FIG. 1 is a cross-sectional view showing a clutch piston according to an embodiment of the present invention;

FIG. 2 is an enlarged cross-sectional view showing a sealing member and a vicinity thereof in the clutch piston of FIG. 1;

FIG. 3 is a cross-sectional view showing an example of a manufacturing process of a part to which the sealing member of FIG. 2 is attached;

FIG. 4 is an enlarged cross-sectional view showing a sealing member and a vicinity thereof according to a comparative example;

FIG. 5 is a cross-sectional view showing an example of a manufacturing process of a part to which the sealing member of FIG. 4 is attached; and

FIG. 6 is a cross-sectional view showing a clutch piston according to another embodiment of the present invention.

### DESCRIPTION OF EMBODIMENTS

Hereinafter, with reference to the accompanying drawings, embodiments according to the present invention will be described. It is of note that the drawings are not necessarily to scale, and certain features may be exaggerated or omitted.

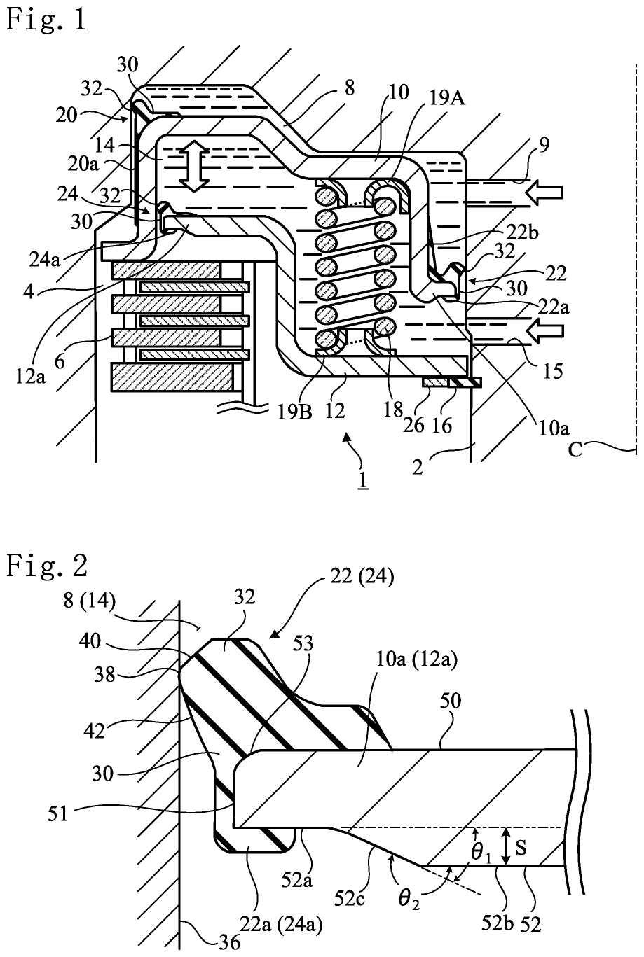

As shown in FIG. 1, the clutch piston 1 according to an embodiment is used to actuate a multiplate clutch 6 disposed within a clutch chamber 4 of a clutch housing 2 of an automobile. The multiplate clutch 6 is provided, for example, in an automatic transmission (AT) or a continuously variable transmission (CVT). A portion of the clutch chamber 4 is utilized as a piston chamber 8 in which the clutch piston 1 is disposed. An oil supply path 9 formed in the clutch housing 2 is connected to the piston chamber 8, and the pressure in the piston chamber 8 can be changed under supply of oil from the oil supply path 9.

The clutch piston 1 according to the embodiment includes a piston 10, a canceller 12, and a return spring 18.

The piston 10 is generally formed by bending a sheet metal, for example, by press working. The piston 10 reciprocates in the piston chamber 8 in response to a change in the pressure of the oil in the piston chamber 8 supplied from the oil supply path 9.

The canceller 12 is also generally formed by bending a sheet metal, for example, by press working. The canceller 12 faces the piston 10 and defines an oil chamber 14 between the canceller 12 and the piston 10. An oil supply path 15 formed in the clutch housing 2 is connected to the oil chamber 14, and the oil is supplied from the oil supply path 15.

The canceller 12 is supported by a seal washer 16 fixed to the clutch housing 2, and movement of the canceller 12, downward in FIG. 1, is restricted by the seal washer 16.

The return spring 18 is a spring (e.g., a coil spring) disposed inside the oil chamber 14 and is supported by the canceller 12 to constantly exert on the piston 10 with a force that pushes back the piston 10 toward the far side of the piston chamber 8 (upward in FIG. 1). An end of the return spring 18 is attached to a spring seat 19A fixed to the piston 10, whereas the other end of the return spring 18 is attached to a spring seat 19B fixed to the canceller 12.

When the pressure of the oil in the piston chamber 8 increases due to adjustment of the oil supply path 9, the piston 10 moves downward in FIG. 1 against the force of the return spring 18 to fasten the multiplate clutch 6, thereby allowing the multiplate clutch 6 to transmit power for the automobile. When the pressure of the oil in the piston chamber 8 decreases due to adjustment of the oil supply path 9, the force of the return spring 18 pushes the piston 10 back into the piston chamber 8, thereby releasing the fastening of the multiplate clutch 6 and stopping transmission of power. Thus, the piston 10 reciprocates relative to the clutch housing 2 and the canceller 12.

In FIG. 1, there is shown the common axis C of the clutch housing 2, the multiplate clutch 6, the piston 10, and the canceller 12. In FIG. 1 there are shown only the left portions of the clutch housing 2, the multiplate clutch 6, the piston 10, and the canceller 12, which have a rotationally symmetrical structure. Thus, the piston 10 and the canceller 12 are annular.

The clutch housing 2, the piston 10, and the canceller 12 rotate about the common axis C. Under the rotation of the clutch housing 2 and the piston 10, the oil in the piston chamber 8 is subject to a centrifugal force. The canceller 12 defines an oil chamber 14 on the opposite side of the piston 10 from the piston chamber 8. The canceller 12 is provided to generate a centrifugal force in the oil within the oil chamber 14 that counteracts the centrifugal force in the oil within the piston chamber 8. The cancellation of the centrifugal forces improves a response of the piston 10 to the pressure change of the oil in the piston chamber 8 (and thus, a response of the multiplate clutch 6).

The canceller is also referred to as a balancer. The clutch piston provided with such a canceller is referred to as a bonded piston seal or a seal bonded piston.

To seal the oil in the piston chamber 8, the clutch piston 1 further includes an external piston sealing member 20 and an internal piston sealing member 22. The external piston sealing member 20 is secured to a corner of the outer wall of the piston 10 and is in slidable contact with the outer wall surface of the piston chamber 8. The internal piston sealing member 22 is secured to the inner edge 10a of the piston 10 and is in slidable contact with the inner wall surface of the piston chamber 8.

To seal the oil in the oil chamber 14, the clutch piston 1 further includes a canceller sealing member 24. The canceller sealing member 24 is secured to the outer edge 12a of the canceller 12 and is in slidable contact with the outer wall surface of the oil chamber 14 (i.e., the inner wall surface of the piston 10).

The gap between the inner edge of the canceller 12 and the clutch housing 2 is sealed with an annular seal washer 16. To regulate expansion of the diameter of the seal washer 16 caused by centrifugal force, a stopper 26 is disposed around the seal washer 16. Instead of the annular seal washer 16, a C-shaped seal washer, a portion of which in the circumferential direction is discontinuous, may be used to allow a small amount of oil to flow out of the oil chamber 14 through the discontinuous portion.

Each of the sealing members 20, 22, and 24 has a proximal portion 30 mounted to the piston 10 or canceller 12, and a seal lip 32 that protrudes from the proximal portion 30. Each seal lip 32 protrudes from the proximal portion 30 toward the farther side of the piston chamber 8 (upward in FIG. 1) in the direction of movement of the piston 10.

The sealing members 20, 22, and 24 each have parts other than the seal lip 32, and these parts vary depending on the sealing members 20, 22, and 24. More specifically, as shown in FIG. 1, the proximal portion 30 of the external piston sealing member 20 is fixed to the corner of the outer wall of the piston 10. The external piston sealing member 20 further has an extended portion 20a that extends from its proximal portion 30 and covers a portion of the outer peripheral surface of the piston 10.

The proximal portion 30 of the internal piston sealing member 22 covers both sides and the end surface of the inner edge 10a of the piston 10 and is fixed to the inner edge 10a. Accordingly, the proximal portion 30 of the internal piston sealing member 22 has a portion 22a that covers the near-side face of the inner edge 10a of the piston 10 (the surface disposed on the near side of the piston chamber 8). In addition, the internal piston sealing member 22 has an extended portion 22b that extends from its proximal portion 30 and covers a portion of the inner circumferential surface of the piston 10.

The proximal portion 30 of the canceller sealing member 24 has a portion 24a that covers the near-side face of the outer edge 12a of the canceller 12 (the surface disposed on the near side of the oil chamber 14).

Each sealing member is formed from an elastomer. For example, the sealing member may be formed by deploying the piston 10 or the canceller 12 and an elastomer material, which is a material of the sealing member, inside a mold and pressing the elastomer material. Alternatively, the sealing member may be formed by use of injection molding.

FIG. 2 is an enlarged view showing the internal piston sealing member 22 or canceller sealing member 24 and a vicinity thereof. Illustration of the extended portion 22b of the internal piston sealing member 22 is omitted.

The internal piston sealing member 22 is fixed to the inner edge 10a of the piston 10, and the canceller sealing member 24 is fixed to the outer edge 12a of the canceller 12.

The seal lip 32 of the internal piston sealing member 22 protrudes from the proximal portion 30 toward the farther side in the piston chamber 8 in the direction of movement of the piston 10. The seal lip 32 of the canceller sealing member 24 protrudes from the proximal portion 30 toward the farther side in the oil chamber 14 in the direction of movement of the piston 10.

When the piston 10 reciprocates, each seal lip 32 slides on the wall surface 36. More specifically, the distal portion 38 of the seal lip 32 of the internal piston sealing member 22 is brought into contact with the wall surface of the piston chamber 8 (i.e., the wall surface of the clutch housing 2), and when the piston 10 reciprocates, the distal portion 38 slides on the wall surface 36 of the piston chamber 8. The distal portion 38 of the seal lip 32 of the canceller sealing member 24 is brought into contact with the internal wall surface, which forms the oil chamber 14, of the piston 10, and when the piston 10 reciprocates, the distal portion 38 slides on the wall surface 36 of the oil chamber 14.

Each seal lip 32 has a far-side face 40, having a shape of a truncated cone, disposed on the far side of the piston chamber 8 and adjacent to the wall surface 36, and a near-side face 42, having a shape of a truncated cone, disposed on the near side of the piston chamber 8 and disposed adjacent to the wall surface 36. The portion at which the far-side face 40 and the near-side face 42 intersect with each other is the distal portion 38.

Each of the inner edge 10a of the piston 10 and the outer edge 12a of the canceller 12 extends in a direction perpendicular to the wall surface 36. Each of the inner edge 10a of the piston 10 and the outer edge 12a of the canceller 12 has a far-side face 50, an end surface 51, and a near-side face 52. The far-side face 50 is disposed on the far side of the piston chamber 8 or the oil chamber 14. The near-side face 52 is disposed on the near side of the piston chamber 8 or the oil chamber 14.

In this embodiment, the corner 53 between the far-side face 50 and the end surface 51 is formed in an arc shape, but it may be formed to be a right angle or tapered.

The near-side face 52 has a recessed surface 52a, a projecting surface 52b, and an inclined surface 52c. The portion 22a of the proximal portion 30 of the internal piston sealing member 22 is fixed to the recessed surface 52a of the near-side face 52 of the inner edge 10a of the piston 10. Accordingly, the proximal portion 30 of the internal piston sealing member 22 covers the far-side face 50, the end surface 51, the recessed surface 52a, and the corner 53 over the entire circumference. The portion 24a of the proximal portion 30 of the canceller sealing member 24 is fixed to the recessed surface 52a of the outer edge 12a of the canceller 12. Accordingly, the proximal portion 30 of the canceller sealing member 24 covers the far-side face 50, the end surface 51, the recessed surface 52a, and the corner portion 53 over the entire circumference.

The projecting surface 52b is disposed on the nearer side of the piston chamber 8 than the recessed surface 52a. In this embodiment, the projecting surface 52b is parallel to the recessed surface 52a, but it need not be parallel to the recessed surface 52a. The inclined surface 52c is inclined relative to the recessed surface 52a and the projecting surface 52b, and connects the recessed surface 52a and the projecting surface 52b. The inclination angle 0₁ of the inclined surface 52c relative to the recessed surface 52a and the projecting surface 52b is 45 degrees or less. The angle θ₂ between the inclined surface 52c and the projecting surface 52b is greater than 180 degrees and equal to or less than 225 degrees (θ₂=θ₁+180 degrees).

The level difference S between the concave surface 52a and the projecting surface 52b is, for example, 0.5 mm or more.

The portion 22a of the proximal portion 30 of the internal piston sealing member 22 is disposed on the farther side of the piston chamber 8 than the projecting surface 52b of the near-side face 52. That is, the thickness of the portion 22a is less than the level difference S. Therefore, the entirety of the internal piston sealing member 22 is disposed on the farther side of the piston chamber 8 than the projecting surface 52b. Accordingly, the internal piston sealing member 22 can be downsized and can be placed in a confined space.

The portion 24a of the proximal portion 30 of the canceller sealing member 24 is disposed on the farther side of the oil chamber 14 than the projecting surface 52b of the near-side face 52. That is, the thickness of the portion 24a is less than the level difference S. Therefore, the entirety of the canceller sealing member 24 is disposed on the farther side of the piston chamber 8 than the projecting surface 52b. Accordingly, the canceller sealing member 24 can be downsized and can be placed in a confined space.

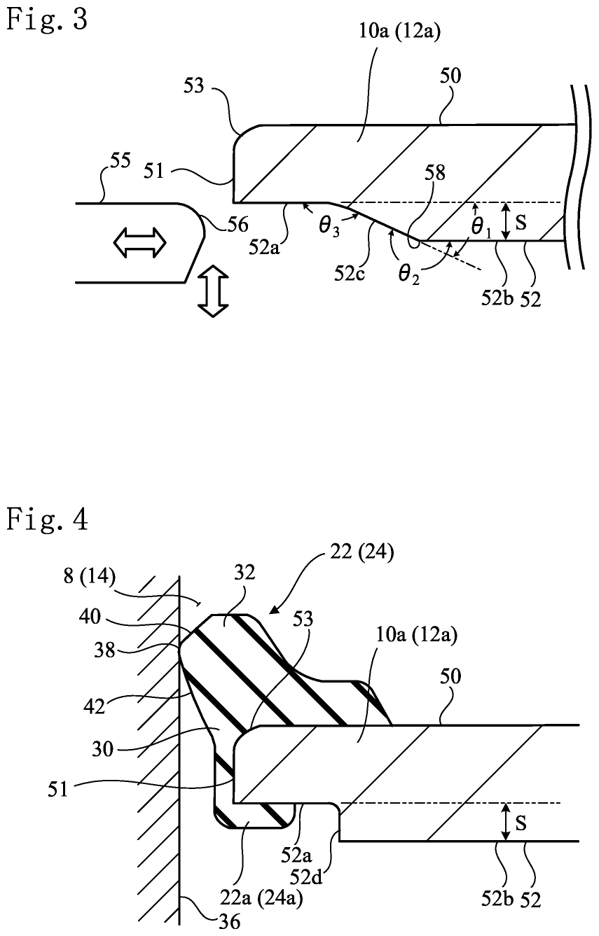

FIG. 3 is a cross-sectional view showing an example of a manufacturing process of a part to which the sealing member 22 or 24 is attached (the inner edge 10a of the piston 10 or the outer edge 12a of the canceller 12). As described above, the piston 10 and the canceller 12 are generally formed by bending sheets of metal, for example, by press working. However, the inner edge 10a of the piston 10 or the outer edge 12a of the canceller 12 can be finished by cutting with the use of a cutting tool (e.g. a tool bit 55 for lathes). The tool bit 55 has a nose 56 at its tip.

In this embodiment, the near-side face 52 of the inner edge 10a of the piston 10, to which the internal piston sealing member 22 is attached, has an inclined surface 52c that connects the recessed surface 52a and the projecting surface 52b. Since the inclined surface 52c is inclined relative to the projecting surface 52b, burrs are less likely to occur at the boundary 58 between the inclined surface 52c and the projecting surface 52b during the cutting process for the inner edge 10a of the piston 10, and thus, a process for removing burrs either is not necessary or takes only a short time.

Furthermore, since the angle θ₃ between the inclined surface 52c and the recessed surface 52a is obtuse (θ₃=180 degrees−θ₁), the nose 56 at the tip of the tool bit 55 for processing the inclined surface 52c and the recessed surface 52a may have a large radius of curvature. Accordingly, the processing time can be shortened. Thus, it is easy to manufacture the inner edge 10a of the piston 10 to which the internal piston sealing member 22 is attached.

The same is true for the near-side face 52 of the outer edge 12a of the canceller 12 to which the canceller sealing member 24 is attached.

As described above, the angle θ₂ between the inclined surface 52c and the projecting surface 52b is preferably greater than 180 degrees and equal to or less than 225 degrees. In this case, burrs are less likely to occur at the boundary 58 between the inclined surface 52c and the projecting surface 52b during the cutting process of the canceller 12, and thus, a process for removing burrs either is not necessary or takes only a short time.

FIG. 4 is an enlarged view showing an internal piston sealing member 22 or a canceller sealing member 24 and a vicinity thereof according to a comparative example. Illustration of the extended portion 22b of the internal piston sealing member 22 is omitted. In this comparative example, the internal piston sealing member 22 or the canceler sealing member 24 is the same as the internal piston sealing member 22 or the canceler sealing member 24 of FIG. 2. Illustration of the extended portion 22b of the internal piston sealing member 22 is omitted.

In the comparative example of FIG. 4, the near-side face 52 has a recessed surface 52a, a projecting surface 52b, and a connecting end surface 52d. The connecting end surface 52d is perpendicular to the recessed surface 52a and the projecting surface 52b, and connects the recessed surface 52a and the projecting surface 52b.

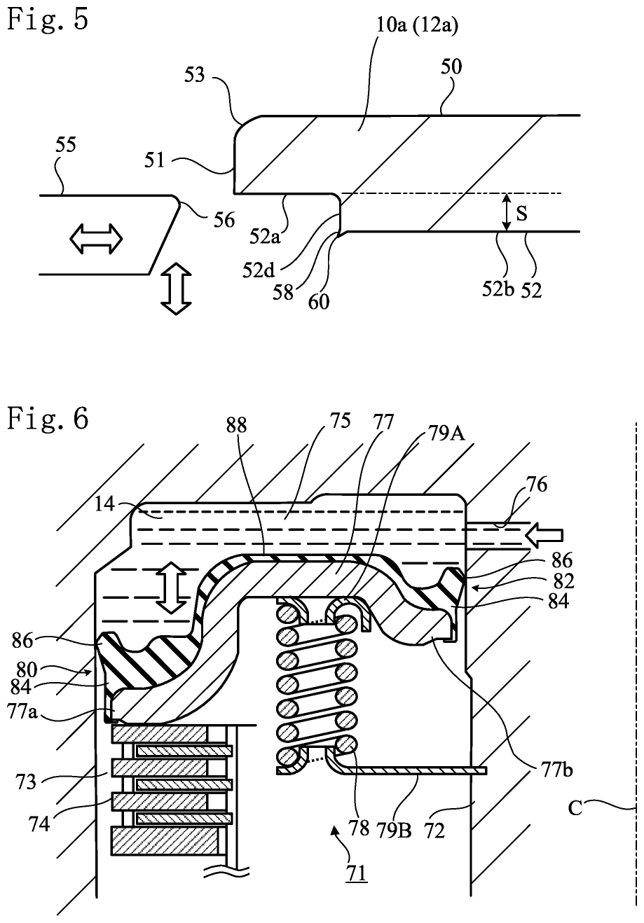

FIG. 5 is a cross-sectional view showing an example of a manufacturing process of the part to which the sealing member 22 or 24 of FIG. 4 is attached (the inner edge 10a of the piston 10 or the outer edge 12a of the canceller 12). The piston 10 and the canceller 12 are generally formed by bending sheets of metal, for example, by press working. However, the inner edge 10a of the piston 10 and the outer edge 12a of the canceller 12 can be finished by cutting with the use of, for example, a tool bit 55 for lathes. The tool bit 55 has a nose 56 at its tip.

In the comparative example, the near-side face 52 of the inner edge 10a of the piston 10, to which the internal piston sealing member 22 is attached, has the connecting end surface 52d that connects the recessed surface 52a and the projecting surface 52b. Since the connecting end surface 52d is perpendicular to the projecting surface 52b, burrs 60 are likely to occur at the boundary 58 between the connecting end surface 52d and the projecting surface 52b during the cutting process of the inner edge 10a of the piston 10, and thus, a process for removing burrs 60 may be necessary.

Furthermore, since the angle between the connecting end surface 52d and the recessed surface 52a is perpendicular, the nose 56 at the tip of the tool bit 55 for processing the connecting end surface 52d and the recessed surface 52a should have a small radius of curvature. In an initial phase of the cutting work, a nose 56 with a large radius of curvature may be used, but should be replaced at a later phase with a nose 56 with a small radius of curvature. Such replacement results in a long processing time. Thus, in the comparative example, manufacturing of the inner edge 10a of the piston 10 to which the internal piston sealing member 22 is attached is problematic.

The same is true for the near-side face 52 of the outer edge 12a of the canceller 12 to which the canceller sealing member 24 is attached.

FIG. 6 is a cross-sectional view showing a clutch piston 71 according to another embodiment of the present invention. The clutch piston 71 is used to actuate a multiplate clutch 74 disposed within a clutch chamber 73 of a clutch housing 72 of an automobile. A portion of the clutch chamber 73 is utilized as a piston chamber 75 in which the clutch piston 71 is disposed. An oil supply path 76 formed in the clutch housing 72 is connected to the piston chamber 75, and the pressure in the piston chamber 75 can be changed under supply of oil from the oil supply path 76.

In the embodiment of FIG. 6, the clutch piston 71 does not have a canceller and includes a piston 77 and a return spring 78.

The piston 77 is generally formed by bending a sheet metal, for example, by press working. The piston 77 reciprocates in the piston chamber 75 in response to a change in the pressure of the oil in the piston chamber 75 supplied from the oil supply path 76.

The return spring 78 is a spring (e.g., a coil spring) disposed on the opposite side from the piston chamber 75 and is supported by the clutch housing 72 to constantly exert on the piston 77 a force that pushes back the piston 77 toward the far side of the piston chamber 75 (upward in FIG. 6). An end of the return spring 78 is attached to a spring seat 79A fixed to the piston 77, whereas the other end of the return spring 78 is attached to a spring seat 79B fixed to the clutch housing 72.

When the pressure of the oil in the piston chamber 75 increases due to adjustment of the oil supply path 76, the piston 77 moves downward in FIG. 6 against the force exerted by the return spring 78 to fasten the multiplate clutch 74, thereby allowing the multiplate clutch 74 to transmit power for the automobile. When the pressure of the oil in the piston chamber 75 decreases due to adjustment of the oil supply path 76, the force exerted by the return spring 78 pushes the piston 77 back into the piston chamber 75, thereby releasing the fastening of the multiplate clutch 74 and stopping transmission of power. Thus, the piston 77 reciprocates relative to the clutch housing 72.

In FIG. 6, there is shown the common axis C of the clutch housing 72, the multiplate clutch 74, and the piston 77. In FIG. 6, there are shown only the left portions of the clutch housing 72, the multiplate clutch 74, and the piston 77, which have a rotationally symmetrical structure. Thus, the piston 77 is annular. The clutch housing 72 and piston 77 rotate about the common axis C.

To seal the oil in the piston chamber 75, the clutch piston 71 further includes an external piston sealing member 80 and an internal piston sealing member 82. The external piston sealing member 80 is secured to the outer edge 77a of the piston 77 and is in slidable contact with the outer wall surface of the piston chamber 75. The internal piston sealing member 82 is secured to the inner edge 77b of the piston 77 and is in slidable contact with the inner wall surface of the piston chamber 75.

Each of the sealing members 80 and 82 has a proximal portion 84 mounted to the piston 77 and a seal lip 86 that protrudes from the proximal portion 84. Each seal lip 86 protrudes from the proximal portion 84 toward the farther side of the piston chamber 75 (upward in FIG. 6) in the direction of movement of the piston 77, and is in slidable contact with the wall surface of the piston chamber 75.

Each sealing member is formed from an elastomer. For example, the sealing member may be formed by deploying the piston 77 and an elastomer material, which is the material of the sealing member, inside a mold and pressing the elastomer material. Alternatively, the sealing member may be formed by use of injection molding.

In this embodiment, the proximal portion 84 of the external piston sealing member 80 and the proximal portion 84 of the internal piston sealing member 82 are connected via a connecting portion 88. Consequently, the sealing members 80 and 82 are integrally formed. However, the connecting portion 88 is not absolutely necessary, and the sealing members 80 and 82 may be separate from each other.

Although an enlarged illustration of the outer edge 77a and the inner edge 77b of the piston 77 is omitted, each of the outer edge 77a and the inner edge 77b of the piston 77, to which the sealing members 80 and 82 are attached, has a far-side face, an end surface, and a near-side face, similarly to the inner edge 10a of the piston 10 and the outer edge 12a of the canceller 12 in the embodiment shown in FIGS. 1 to 3. The far-side face is disposed on the far side of the piston chamber 75. The near-side face is disposed on the near side of the piston chamber 75.

The near-side face disposed on the near side of the piston chamber 75 has a recessed surface to which the proximal portion 84 of the sealing member 80 or 82 is fixed, a projecting surface disposed on the nearer side than the recessed surface, and an inclined surface inclined relative to the recessed surface and the projecting surface and connecting the recessed surface and the projecting surface. The proximal portion 84 of each of the sealing members 80 and 82 is disposed on the farther side of the piston chamber 75 than the projecting surface of the near-side face. Therefore, the entirety of each of the sealing members 80 and 82 is disposed on the farther side of the piston chamber 75 than the projecting surface.

Thus, in this embodiment, the same advantages as those of the embodiment shown in FIGS. 1 to 3 are achieved.

Although the present invention has been illustrated and described above with reference to preferred embodiments of the invention, it will be understood that changes in form and detail are possible to those skilled in the art without departing from the scope of the invention as claimed. It is intended that such changes, variations, and modifications should remain within the scope of the present invention.

For example, in the embodiment shown in FIGS. 1 to 3, the same improvement is applied to the parts to which two sealing members 22 and 24 are attached, but the above improvement may be applied only to a part to which any one of the sealing members 22 and 24 is attached. In the embodiment shown in FIG. 6, the same improvement is applied to the parts to which two sealing members 80 and 82 are attached, but the above improvement may be applied only to a part to which any one of the sealing members 80 and 82 is attached.

In the embodiment shown in FIGS. 1-3, the clutch piston 1 is a bonded piston seal having a canceller 12. However, as shown in FIG. 6, the present invention may be applied to a clutch piston that does not have a canceller, i.e., a clutch piston that is not a bonded piston seal.

The shape of the seal lips 32 and 86 of the sealing members 22, 24, 80, and 82 is not limited to the embodiments described above, and may be other shapes.

Aspects of the present invention are also set out in the following numbered clauses:

Clause 1. A clutch piston comprising:
a piston that reciprocates in a piston chamber into which oil flows; and
a sealing member configured to seal oil in the piston chamber, the sealing member comprising a proximal portion mounted to an end of the piston and a seal lip that slides on a wall surface of the piston chamber when the piston reciprocates,
the end of the piston extending in a direction intersecting the wall surface, the end comprising a far-side face disposed on a far side of the piston chamber and a near-side face disposed on a near side of the piston chamber,
the near-side face comprising a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

Clause 2. The clutch piston according to clause 1, wherein an entirety of the sealing member is disposed on a farther side of the piston chamber than the projecting surface.

In this case, the sealing member can be downsized and can be placed in a confined space.

Clause 3. The clutch piston according to clause 1 or 2, wherein an angle between the inclined surface and the projecting surface is greater than 180 degrees and equal to or less than 225 degrees.

In this case, burrs are less likely to occur at the boundary between the inclined surface and the projecting surface during the cutting process of the canceller, and thus, a process for removing burrs either is not necessary or takes only a short time.

Clause 4. A clutch piston comprising:
a piston that reciprocates in a piston chamber into which oil flows;
a canceller that faces the piston and defines an oil chamber between the piston and the canceller; and
a sealing member configured to seal oil in the oil chamber, the sealing member comprising a proximal portion mounted to an end of the canceller and a seal lip that slides on an internal wall surface of the piston when the piston reciprocates, the internal wall surface of the piston forming the oil chamber,
the end of the canceller extending in a direction intersecting the internal wall surface, the end comprising a far-side face disposed on a far side of the oil chamber and a near-side face disposed on a near side of the oil chamber,
the near-side face comprising a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

Clause 5. The clutch piston according to clause 4, wherein an entirety of the sealing member is disposed on a farther side of the oil chamber than the projecting surface.

In this case, the sealing member can be downsized and can be placed in a confined space.

Clause 6. The clutch piston according to clause 4 or 5, wherein an angle between the inclined surface and the projecting surface is greater than 180 degrees and equal to or less than 225 degrees.

In this case, burrs are less likely to occur at the boundary between the inclined surface and the projecting surface during the cutting process of the canceller, and thus, a process for removing burrs either is not necessary or takes only a short time.

### REFERENCE SYMBOLS

1, 71: Clutch piston

2, 72: Clutch housing

8, 75: Piston chamber

10, 77: Piston

10a: Inner edge of piston 10

12: Canceller

12a: Outer edge of canceller 12

14: Oil chamber

22: Internal piston sealing member

24: Canceller sealing member

30: Proximal portion

32: Seal lip

36: Wall surface

50: Far-side face

52: Near-side face

52a: Recessed surface

52b: Projecting surface

52c: Inclined surface

77a: Outer edge of piston 77

77b: Inner edge of piston 77

80: External piston sealing member

82: Internal piston sealing member

84: Proximal portion

86: Seal lip

1. A clutch piston comprising:
a piston that reciprocates in a piston chamber into which oil flows; and
a sealing member configured to seal oil in the piston chamber, the sealing member comprising a proximal portion mounted to an end of the piston and a seal lip that slides on a wall surface of the piston chamber when the piston reciprocates,
the end of the piston extending in a direction intersecting the wall surface, the end comprising a far-side face disposed on a far side of the piston chamber and a near-side face disposed on a near side of the piston chamber,
the near-side face comprising a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

2. The clutch piston according to claim 1, wherein an entirety of the sealing member is disposed on a farther side of the piston chamber than the projecting surface.

3. The clutch piston according to claim 1, wherein an angle between the inclined surface and the projecting surface is greater than 180 degrees and equal to or less than 225 degrees.

4. A clutch piston comprising:
a piston that reciprocates in a piston chamber into which oil flows;
a canceller that faces the piston and defines an oil chamber between the piston and the canceller; and
a sealing member configured to seal oil in the oil chamber, the sealing member comprising a proximal portion mounted to an end of the canceller and a seal lip that slides on an internal wall surface of the piston when the piston reciprocates, the internal wall surface of the piston forming the oil chamber,
the end of the canceller extending in a direction intersecting the internal wall surface, the end comprising a far-side face disposed on a far side of the oil chamber and a near-side face disposed on a near side of the oil chamber,
the near-side face comprising a recessed surface to which the proximal portion of the sealing member is mounted, a projecting surface disposed on a nearer side of the piston chamber than the recessed surface, and an inclined surface inclined relative to the recessed surface and the projecting surface and connecting the recessed surface and the projecting surface.

5. The clutch piston according to claim 4, wherein an entirety of the sealing member is disposed on a farther side of the oil chamber than the projecting surface.

6. The clutch piston according to claim 4, wherein an angle between the inclined surface and the projecting surface is greater than 180 degrees and equal to or less than 225 degrees.

7. The clutch piston according to claim 2, wherein an angle between the inclined surface and the projecting surface is greater than 180 degrees and equal to or less than 225 degrees.

8. The clutch piston according to claim 5, wherein an angle between the inclined surface and the projecting surface is greater than 180 degrees and equal to or less than 225 degrees.
